(19) United States
(12) Patent Application Publication
(10) Pub. No.: US 2024/0277559 A1
(43) Pub. Date: Aug. 22, 2024

(54) Device for testicle stimulation

(71) Applicant: Taylor Jacob Marchand, Santa Rosa, CA (US)

(72) Inventor: Taylor Jacob Marchand, Santa Rosa, CA (US)

(21) Appl. No.: 18/111,596

(22) Filed: Feb. 19, 2023

Related U.S. Application Data
(63) Continuation-in-part of application No. 16/888,657, filed on May 29, 2020, now abandoned.

(51) Int. Cl. A61H 19/00

(52) U.S. Cl. CPC A61H 19/32; A61H 2201/0192; A61H 2201/1253; A61H 2201/149; A61H 2201/163; A61H 2201/1645; A61H 2201/1676

(57) ABSTRACT

Disclosed herein is a device that compresses the scrotum between a stationary jaw and a movable jaw in order to produce a sexual response. Said jaws are ergonomically shaped to complement the general contours of a human's crotch. Said jaws are interlocked to form a testicle vise by means of an integrated, quick-connect hinge. Said hinge is a slip-joint style hinge whose components are incorporated into the shape of said jaws. Said stationary jaw is translated towards said fixed jaw by means of a single tensioning drive comprising a pivoting adjustment screw. Said adjustment screw pivots around said barrel nut's axis, where said adjustment screw can pivot away from said retrocline-sloped catch plate, thereby allowing a quick release of said device's compression. A vertical ridge in the middle of said stationary jaw splays the wearer's testes into separate compartments, thereby aligning the testes symmetrically to the vertical axis.

### BACKGROUND

Most testicle vises are designed with a lack of ergonomics. The stationary jaw and movable jaw of these vises are flat planes, utilizing simple geometric shapes that do not have a natural fit for a wearer. These inorganic designs inherently suit a wearer in an unnaturally raised position, where the jaws lay tangent to the anterior-most points of a wearer's crotch. This lack of ergonomics places the stationary and movable jaws significantly further away from a wearer's scrotum. When correctly worn, these designs hyperextend the scrotum from a wearer's body. It is desirable to create a similar but improved device that sits flush against the human crotch. By incorporating ergonomic contours into this new design, said improved device will lay flush, i.e. adjacent-to rather than tangent-from a wearer's body, so that hyperextension of the scrotum is minimized.

The inorganic shapes of most testicle vises lead to a second phenomenon in which a wearer has reduced mobility of their legs. The bottom corners of these devices are situated along a wearer's thighs, causing the corners to poke and prod the quadriceps. The rounded corners of these devices have a relatively small, sharp radius, lending themselves to excoriate a wearer's skin. This is unnecessary discomfort, and the potential for injury is enough to discourage a wearer from moving their legs while wearing these devices. It is desirable to create a similar but improved device where the corners nearest the legs have compound curvature that follows the natural arc of a wearer's legs in ambulation, so as not to hamper a wearer's mobility. As most testicle vises require a wearer to insert their genitals through an orifice in both jaws, one jaw at a time, and that most of these devices have a fixed, permanent hinge connected to the jaws, it can be difficult to apply these devices in a one-jaw-at-a-time sequence. The movable jaw can be unwieldy; swinging about uncontrollably, or simply interfere with a wearer while they attempt to fix the stationary jaw around their genitals. It is desirable to create a similar but improved device where the stationary and movable jaws can be disconnected, as a wearer may find it easier to insert the genitals through the stationary jaw prior to connecting the movable jaw.

As the testicles are considerably one of the most sensitive areas of the body, overuse of testicle vises can turn from enjoyable to unbearable in an instant. Most testicle vises employ a tensioning drive that requires a wearer to unscrew a plurality of adjustment screws to relieve the vise's compression. This process is inefficient and slow. It is desirable to create a similar but improved device that uses a single adjustment screw to engage and disengage the vise's action, thereby significantly reducing the time it takes to relieve the vise's compression. Most testicle vises have adjustment screws that do not easily unlatch the stationary jaw from the movable jaw. These screws either require two-handed operation (i.e. fastening the nut while holding the bolt), which is unwieldy and inefficient, or, in other embodiments, the screw is fixed to the stationary jaw in a permanent, rigid position, which requires the nut to be completely unscrewed from the bolt before the vise can be opened. In either case, it is desirable to create a tensioning drive that compresses the vise with one-handed operation, and may also be capable of quickly releasing the vise's compression.

### SUMMARY

Disclosed herein is a device that affects a wearer's arousal state by means of compressing said wearer's testicles. Said device's overall design is a vise with ergonomic shaping. Said device consists of a stationary jaw and a movable jaw which are interlocked to form said vise. Said movable jaw articulates around an interlocked hinge's axis to press a wearer's testicles into said stationary jaw. Said device is worn around a male wearer's genitalia, where said wearer's penis and scrotum are inserted through said stationary jaw, and then said wearer's penis is subsequently inserted through said movable jaw, thereby isolating said wearer's scrotum between said jaws.

Said device is ergonomically contoured to reduce collision with a wearer's thighs and said wearer's lower abdomen and crotch, thereby minimizing negative effects on said wearer's comfort, mobility and ambulation.

Said device's hinge is a quick-connect interlocking slip-joint hinge. The hinge components are incorporated into said stationary and movable jaws, wherein said movable jaw contains male hinge components, and said stationary jaw contains female hinge components. Said male hinge components comprise hinge arms and hinge pins. Said female hinge components comprise hinge cups, a hinge pin alignment track, hinge-arm channels, and a lateral sway limiter comprising hinge-arm chocks.

Said quick-connect hinge interlocks when properly assembled. Said slip-joint hinge has a male hinge pin alignment track which escorts said hinge pins into said hinge cups, wherein said hinge arms are rotated within said hinge-arm channels to create an interlocked assembly, which ensures said jaws cannot accidentally separate during operation.

Said jaws are compressed by means of a single tensioning drive, said tensioning drive comprising an adjustment screw. Said adjustment screw threads into a barrel nut housed in a clevis pivot bracket at the bottom of said stationary jaw, while the head of said adjustment screw latches onto a cusp at the bottom of said movable jaw. Said barrel nut allows said tensioning drive to quickly rotate away from said movable jaw's cusp. The pivoting design of said tensioning drive allows for quick release of said vise's compression.

Said device has a raised medial spline in the center of said stationary jaw which splays a wearer's testicles symmetrically along the vertical axis.

A further understanding of the nature and advantages of the present invention may be realized by reference to the remaining portions of the specification and the drawings.

### DESCRIPTION

### Technical Field

This invention relates to sexual stimulation devices and more particularly to devices that affect a wearer's arousal state by inserting their genitals therein.

### BRIEF DESCRIPTION OF THE DRAWINGS

FIG. 1A is an illustrative diagram of the fully assembled device 501, viewed from the trimetric perspective, 1:0.75 scale. In this projection the movable jaw 101 is interlocked with the stationary jaw 103, as the hinge arms 203, FIG. 2A are rotated inside the hinge-arm channels 215, FIG. 2B.

FIG. 1B is an illustrative diagram showing the fully assembled device 501, viewed from the dimetric perspective, 1:0.75 scale, where the movable jaw 101 and stationary jaw 103 are fully closed (herein referred to as the ‘collateral position’).

FIG. 2A is an illustrative diagram of the movable jaw 101, viewed from the anatomical anterior coronal plane, 1:0.75 scale. The hinge pins 201 are connected to the movable jaw's body 805, FIG. 8B by means of hinge arms 203. When the assembled device 501 is in the collateral position, the hinge arms 203 and movable jaw's body 805, FIG. 8B tessellate with the hinge pin alignment track 605 and hinge-arm chocks 217, FIG. 2B, forming a flush union. When the device is assembled and the stationary and movable jaws 101 & 103 are interlocked, the hinge-arm chocks 217 limit lateral sway of the movable jaw and thereby prohibit accidental disassembly during operation.

221, FIG. 2B is identifying the anatomical superior edge of the stationary jaw 103 for further referencing within this document.

The illustration in 209, FIG. 2B is a depiction of ambulatory contouring, where the anatomical inferior corners of the stationary and movable jaws are shaped with a compound curvature.

FIGS. 3A-3B, are cross-sections illustrating both the general design and connectivity of the integrated quick-connect hinge 301, and also the internal structure of the clevis pivot bracket 211 and the internal structure of the retrocline-sloped catch plate 213, viewed from the isometric perspective, 1:0.75 scale.

The major orifice 207, FIG. 2B of the genital collar 901, FIG. 9A allows a wearer's penis and scrotum to pass through the stationary jaw 103, while the minor orifice 205, FIG. 2A of the penile collar 903, FIG. 9B allows only the penis to pass through the movable jaw 101, thereby isolating a wearer's testicles between the jaws. The size L1 of the minor orifice 205 is lesser than the size L2 of the major orifice 207.

FIG. 2A-2B are illustrative diagrams of ambulatory contouring 209 of the movable jaw 101 and stationary jaw 103, where the compound curvature of the anatomically inferior corners of the stationary and movable jaws reduce collision with a wearer's thighs, and reduce negative effects on a wearer's mobility. The clevis pivot bracket 211 houses the barrel nut 107, where the adjustment screw 105 threads into the barrel nut 107, FIG. 6B and pivots around the barrel nut's axis. The adjustment screw's head 401, FIG. 4A serves as the latch hook, and the adjustment screw's threaded shaft 403 serves as the latch arm. The latch's retrocline-sloped catch plate 213, FIG. 2A, receives the latch hook 401, FIG. 4A and secures it by means of a cusp 803, FIG. SA.

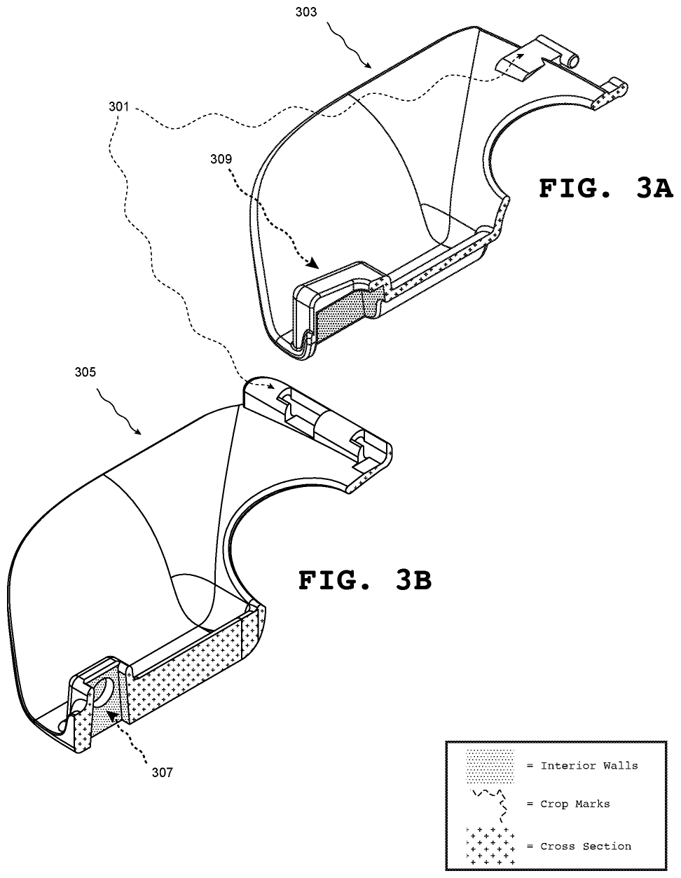

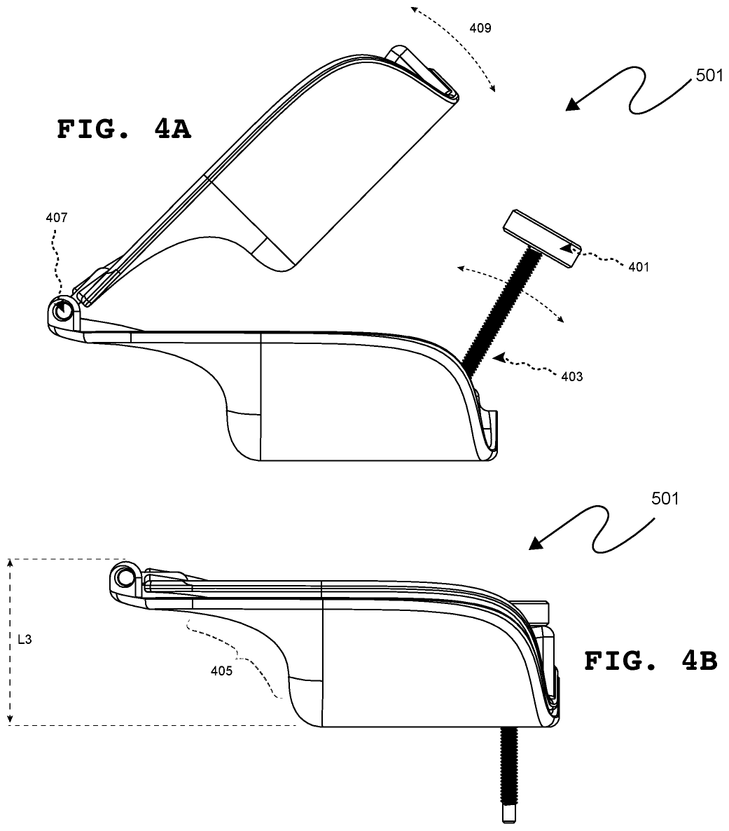

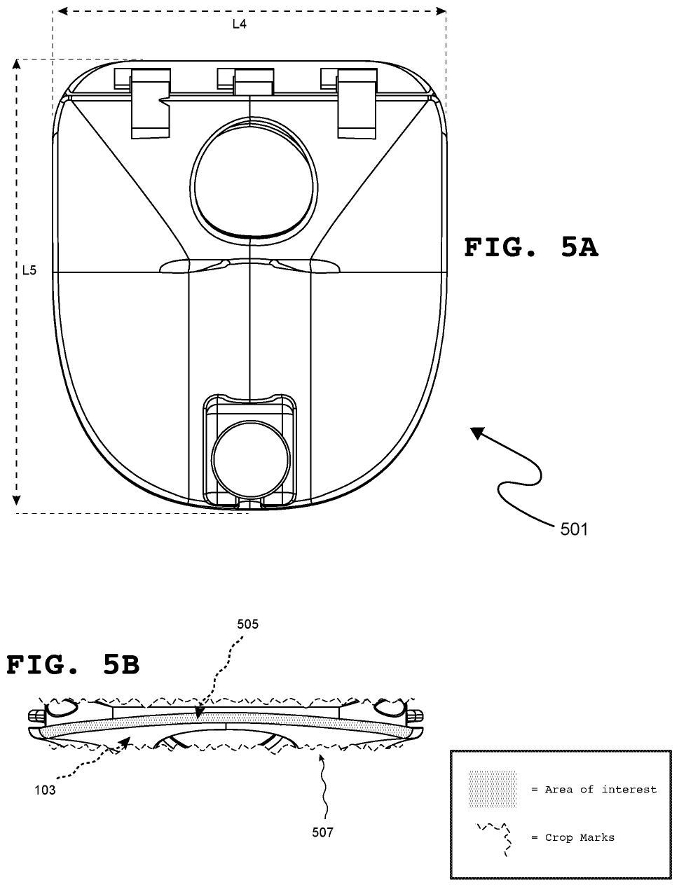

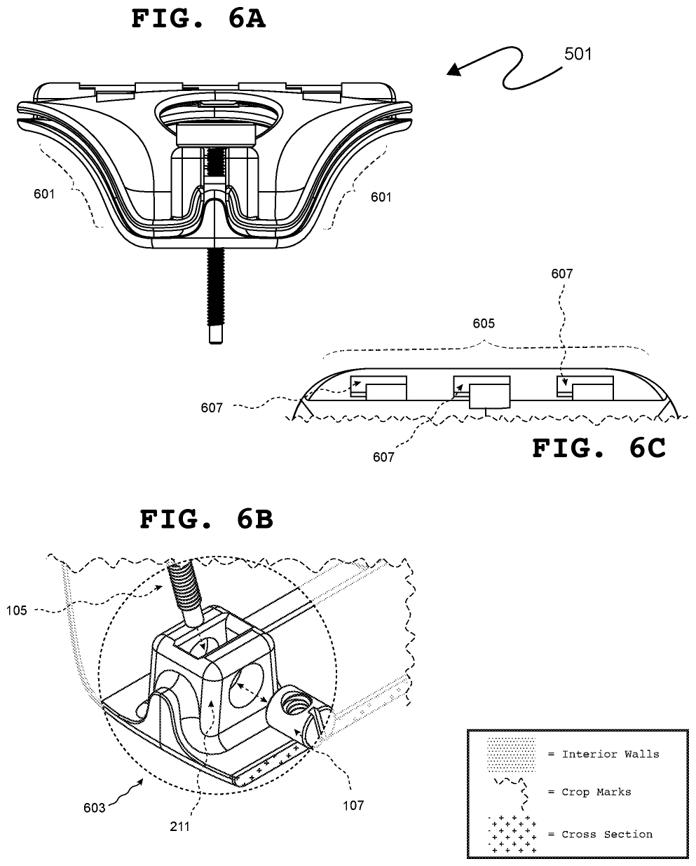

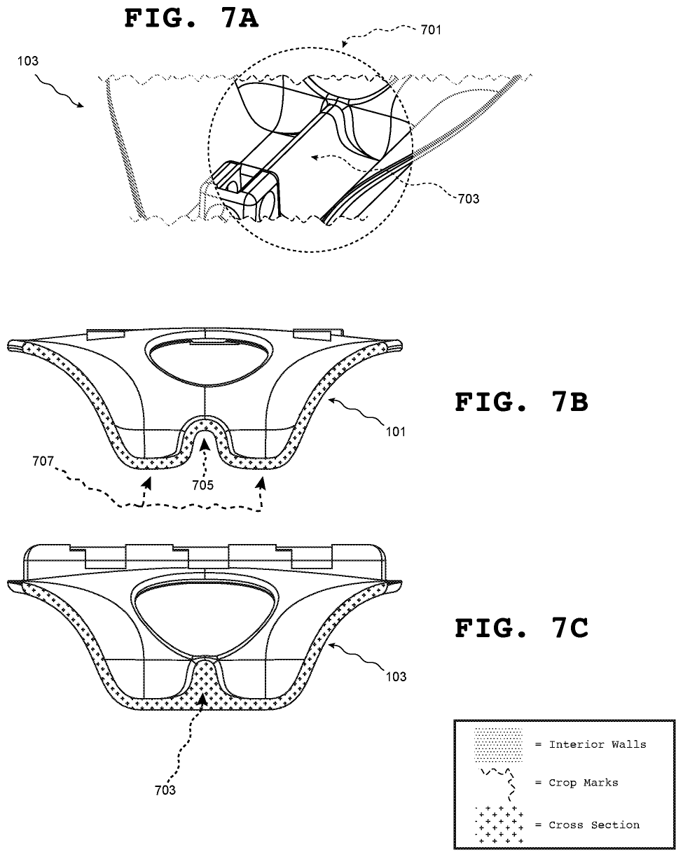

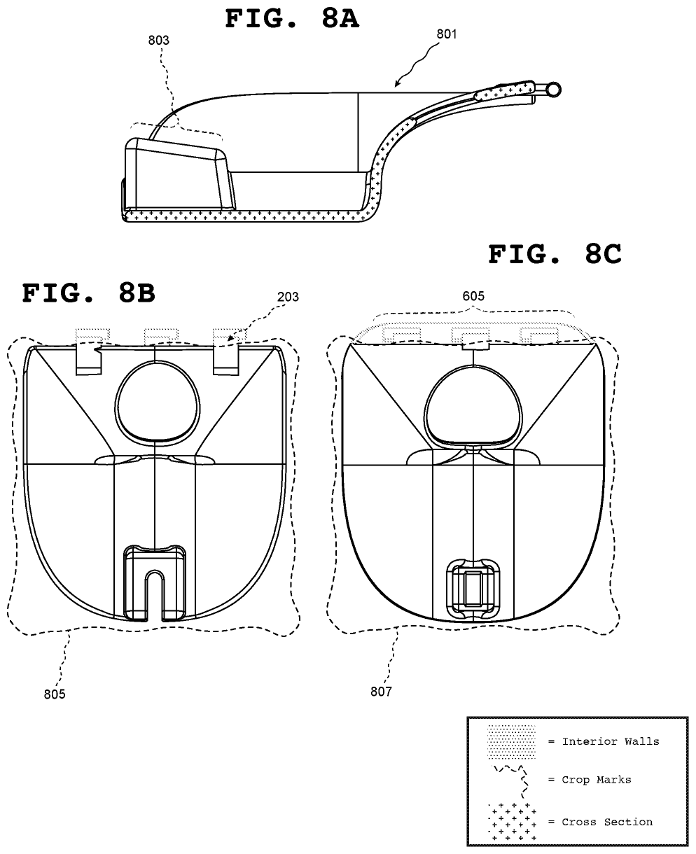

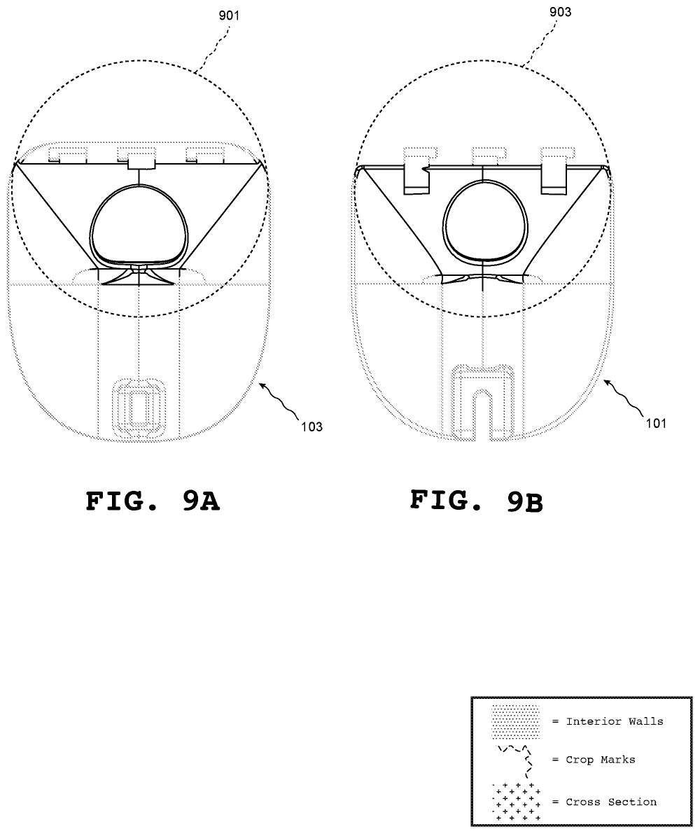

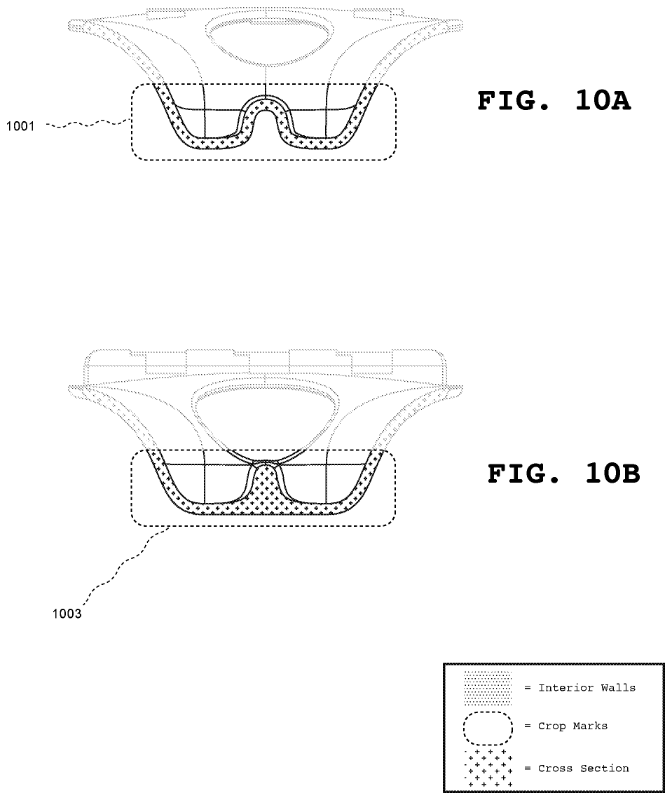

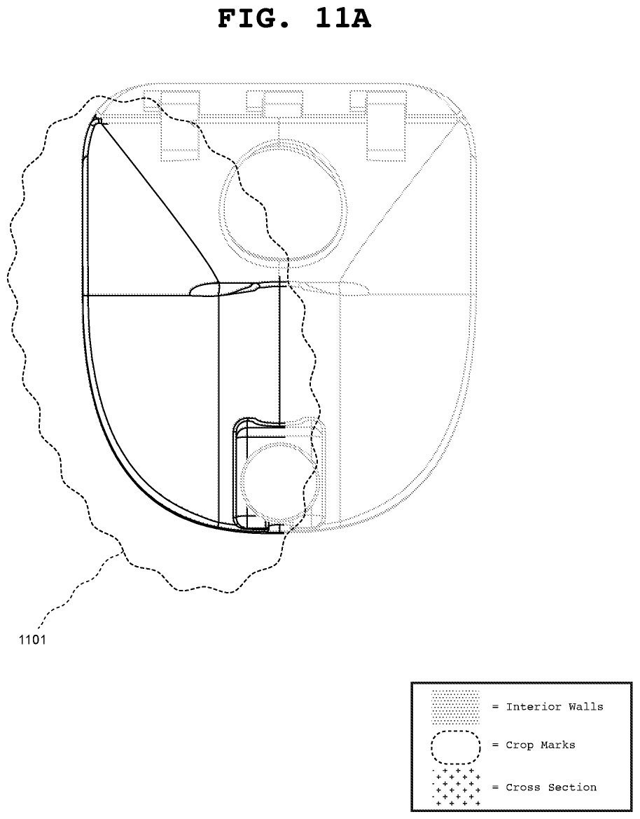

FIG. 3A-3B are illustrative diagrams of the movable jaw's cross-section 303 and the stationary jaw's cross-section 305, viewed from the isometric perspective, 1:0.75 scale. The stationary jaw's cross section 305 illustrates the clevis pivot bracket's internal structure 307. The movable jaw's cross section 303 illustrates the retrocline-sloped catch plate's internal structure 309 which covers the clevis pivot bracket 211, FIG. 2B when the assembled device 501 is in the collateral position.

FIG. 4A is an illustrative diagram of the fully assembled device 501, viewed from the anatomical sagittal plane, 1:0.75 scale. The movable jaw 101 articulates around the stationary jaw 103 on the integrated quick-connect hinge's 301 axis of rotation 409.

FIG. 4B is an illustrative diagram of the approximate overall depth of the fully assembled device 501, viewed from the anatomical sagittal plane, where L3 is approximately 53 millimeters, in the preferred embodiment.

FIG. 5A is an illustrative diagram of the approximate overall width and height of the fully assembled device 501, viewed from the anatomical anterior coronal plane, 1:0.75 scale, where L4 is approximately 127 millimeters, and LS is approximately 148 millimeters, in the preferred embodiment.

FIG. 5B is an illustrative diagram of the fully assembled device's cross section 507, viewed from the anatomical superior transverse plane, 1:0.75 scale. The stationary jaw 103 has hypogastric contouring 505 to reduce collision with a wearer's abdominal region.

FIG. 6A is an illustrative diagram of the fully assembled device 501, viewed from the anatomical inferior transverse plane, 1:0.75 scale. The movable jaw 101 and stationary jaw 103 have adductor contouring 601 to match the contours of a wearer's thighs.

FIG. 6B is an illustrative diagram of the tensioning drive 603, close-up view from the isometric perspective, 1.125:1 scale. The tensioning drive 603 includes the clevis pivot bracket 211, the adjustment screw 105, the barrel nut 107, the retrocline-sloped catch plate 213, FIG. 2A and it's cusp 803, FIG. SA.

FIG. 6C is an illustrative diagram of the hinge pin alignment track 605, section view from the anatomical coronal plane, 1:0.75 scale. The hinge pin alignment track 605 comprises a continuous lateral groove 607, which guides the hinge pins 201 into the hinge cups 407, FIG. 4A.

FIG. 7A is an illustrative cross section of the stationary jaw 103, 1:0.75 scale, where the dashed circle highlights the posteriorly-elongated trough (also referred to herein as the “testicle cup”) 701 which cradles a wearer's testicles between the movable jaw and stationary jaw. The testicle cup 701 has pubic contouring 405, FIG. 4B to reduce collision with a wearer's pubic region.

FIG. 7B-7C are illustrative cross-sections of the movable jaw 101 and stationary jaw 103, viewed from the anatomical inferior transverse plane, 1:0.75 scale. The testicle divider 703, FIG. 7C, is the anterior vertical spline at the center of the testicle cup's 701 base. This spline 703 spans the length of the trough 701. The press relief 705, FIG. 7B, of the movable jaw 101 houses the testicle divider 703 when the stationary and movable jaws are in the collateral position, thereby allowing the jaws to lay flush against each other. The testicle press 707, FIG. 7B, of the movable jaw 101 presses a wearer's testicles into the testicle cup 701.

FIG. 8A is an illustrative diagram of the movable jaw's cross section 801, viewed from the anatomical sagittal plane, 1:0.75 scale, highlighting the cusp of the retrocline-sloped catch plate 803.

FIG. 8B-8C are illustrative diagrams of the movable jaw's body 805, and the stationary jaw's body 807, section view from the anatomical coronal plane, 1:0.50 scale. The movable jaw's body 805 may be considered as any part of the movable jaw 101 that is anatomically inferior to the hinge arms 203. The stationary jaw's body 807 may be considered as any part of the stationary jaw 103 that is anatomically inferior to the hinge pin alignment track 605.

FIG. 9A is an illustrative diagram of the genital collar, section view 901, viewed from the anatomical sagittal plane, 1:0.75 scale. FIG. 9B is an illustrative diagram of the penile collar, section 903, viewed from the anatomical sagittal plane, 1:0.75 scale. In both cases, these collars are defined as the anatomical superior medial faces of their respective jaws.

FIGS. 10A-10B are illustrations of the movable jaw's cross section 1001 and stationary jaw's cross section 1003, viewed from the anatomical inferior transverse plane, 1:0.75 scale. The highlighted section of these drawings illustrate the jaws of the vise, where the movable jaw 1001 presses into the stationary jaw 1003.

FIG. 11A is a section view of one of the two anatomical inferior symmetrical faces of the stationary and movable jaws, viewed from the anatomical anterior coronal plane, 1:0.75 scale. The left anatomical inferior symmetrical face 1101 and its right counterpart are together referred to in this document as the “anatomical inferior symmetrical faces”.

### DESCRIPTION OF THE EMBODIMENTS

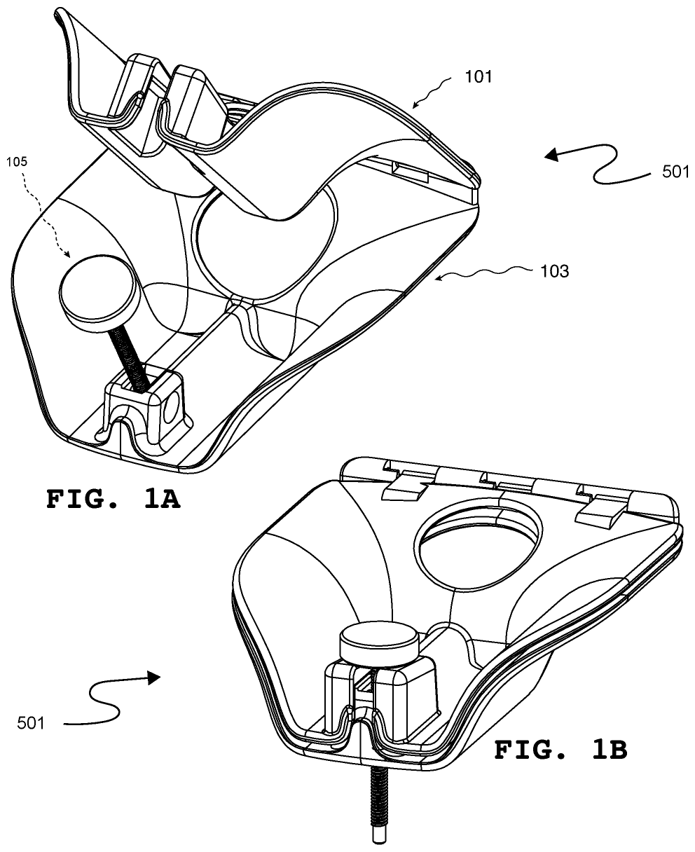

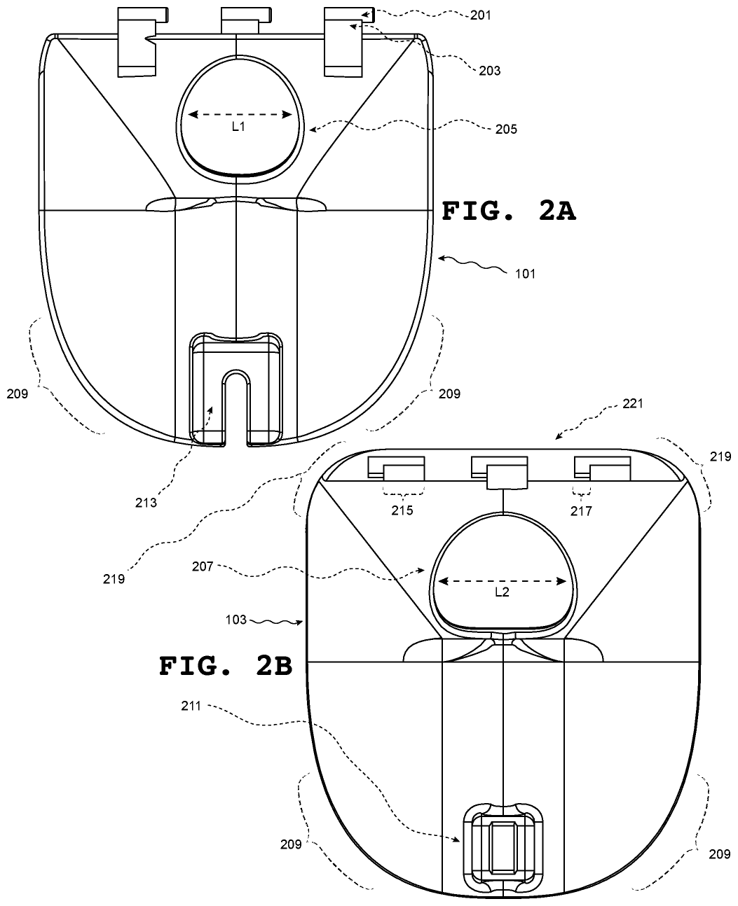

FIG. 1A provides a trimetric perspective of the fully assembled testicle vise in accordance with the invention. In the preferred embodiment, the stationary jaw 103 and the movable jaw 101 are compressed by means of an adjustment screw 105. This tensioning drive allows for a high degree of precision when dialing in a desired amount of pressure. It should be understood, however, that the compression action may be achieved by alternate designs without deviating from the scope or spirit of the invention.

In an alternate embodiment, the stationary and movable jaws may be compressed by means of a ratcheting tensioning system (not shown). While this system may offer different benefits, such as having a potentially smaller footprint or utilizing smaller components and thereby requiring less space and having fewer protruding components, the stepped increments of a ratcheting system do not have the same precision nor linear tensioning action as a screw/torsion-based system does. With such a delicate task as testicle compression, it is desirable to employ the highest degree of tensioning precision as is possible.

In the preferred embodiment, the movable jaw and stationary jaw are interlocked by means of an integrated quick-connect hinge, i.e. the components of the hinge are built into the shape of the stationary and movable jaws. This design reduces the need for excessive hardware, providing the simplest possible method for assembling the device. Additionally, the inclusion of a slip-joint style hinge in the integrated quick-connect hinge allows for the stationary and movable jaws to be separated with relative ease. This slip-joint feature has multiple benefits. One of these benefits is that the disassembled jaws can be sanitized more readily than a device with permanently hinged jaws. Another benefit is that the application of the device to a wearer's body is achieved more easily by outfitting the device in stages. This non-permanent hinge allows a wearer to fasten the device to their genitals one jaw at a time, by first positioning the stationary jaw on a wearer's body, and then subsequently attaching the movable jaw to the stationary jaw, thereby assembling the hinge. As the movable jaw is not attached during the first stage of the assembly process, the movable jaw does not obstruct or interfere with the placement and application of the stationary jaw. The stationary jaw can be properly fitted and adjusted, after which the movable jaw can be subsequently attached, assembled, and properly fitted to a wearer.

In an alternate embodiment, the stationary and movable jaws are hinged together using a permanently fixed hinge (not shown). This alternate embodiment requires more hardware than the preferred embodiment and thus requires extra steps in the manufacturing process. In this alternate embodiment the movable jaw and stationary jaw would be permanently connected to each other. The inability to disconnect and separate these hinges would make application of the device difficult and unwieldy.

In the preferred embodiment, the integrated quick-connect hinge is assembled by aligning the movable jaw perpendicular to the stationary jaw on the anatomical sagittal plane, and then inserting the hinge pins into the hinge pin alignment track. At this stage the device is in the unlocked position. To interlock the stationary and movable jaws, a wearer slides the hinge pins along the hinge pin alignment track and into the hinge cups until the hinge pins are firmly seated. At this point, the hinge arms have cleared the hinge-arm chocks, whereto the hinge arms can be articulated coaxially on the hinge pin's axis, routing the hinge arms in between the hinge-arm channels, further limiting lateral sway of the movable jaw, and locking the hinge pins within the hinge cups. The device is now in the interlocked position.

In the preferred embodiment, FIG. 2A and FIG. 2B illustrate the respective orifices of the stationary and movable jaws where a wearer's genitals are inserted. The dimensions L1 and L2 do not have specific values, rather, the only specification is that L1 is less than L2. In alternate embodiments, the overall size of the invention can be scaled up or down, in order to accommodate different shapes and sizes of a wearer's body. In these embodiments, it is possible for L1 and L2 to scale nonlinearly, relative to the overall scale of the embodiment; therefore it is only necessary that the orifices 205 and 207 follow the rule L1 is less than L2, relative to the scale of the embodiment.

In the preferred embodiment, the stationary jaw and movable jaw have offset orifice diameters to retain a wearer's scrotum within the jaws of the vise. The major orifice 207 of the stationary jaw 103 is large enough to allow insertion of both a wearer's penis and scrotum, while the minor orifice 205 of the movable jaw 101 has a smaller opening, which only allows insertion of said wearer's penis, thereby preventing said scrotum from escaping the vise.

In the preferred embodiment, the device's integrated quick-connect hinge comprises three hinge arms 203 which articulate within the hinge-arm channels 215. The hinge pin alignment track 605 directionality has adverse polarity to the hinge's axis of rotation 409, FIG. 4A, which, when the hinge arms are positioned inside the hinge-arm channels, creates a secure, interlocked connection between the stationary jaw and movable jaw.

In alternate embodiments, it is possible to modify the number of hinge arms and hinge cups used to create the interlocking hinge assembly while still achieving the same general system and assembly. While it is possible to create a hinge with as little as one connection, the preferred embodiment utilizes three hinge arms and hinge cups for redundant stability and reinforcement. The left and right hinge arms balance the stationary and movable jaw's alignment and rotation, while the middle hinge arm relieves tension of the left and right hinge arms, thereby reinforcing the overall strength of the system. In alternate embodiments, tighter design tolerances and/or stronger materials may yield the same interlocking hinge assembly with fewer hinge connections.

In the preferred embodiment, the stationary jaw has a testicle divider 703, FIG. 7C, which helps separate a wearer's left and right testes into separate compartments. The testicle divider may be any form of a partition that separates said testes. In the preferred embodiment, the testicle divider is an anteriorly-protruding spline that runs vertically up the middle of the stationary jaw, starting from the clevis pivot bracket 211, FIG. 6B, extending to the base of the major orifice 207, FIG. 2B.

In an alternate embodiment, the stationary jaw does not have a testicle divider.

In a second alternate embodiment, a wearer's testicles may be separated into separate, ergonomically-contoured concavities. In this alternate embodiment, the testicles are divided not by any form of a ridge or other anterior protrusion, but inversely by the gravity of the depressions in this design. In this embodiment, the posteriorly-concave compartments encourage a wearer's testes to situate themselves in their natural, symmetrical arrangement, with gravity acting as the force which allows the testes to sink into their respective compartments.

The illustration in 405, FIG. 4B is a depiction of the pubic contouring of the device. In the preferred embodiment, the shape of the genital collar 901, FIG. 9A follows the general contour of a wearer's pubic region. This contouring allows the genital collar to sit flush against a wearer's pubic region, effectively minimizing excessive pulling of a wearer's scrotum from their body.

The illustration in 219, FIG. 2B is a depiction of rounding on the anatomical superior corners of the device. As these anatomical superior corners do not contact a wearer's legs, the amount of rounding here is not as critical to the invention as the rounding of the anatomical inferior corners are. In alternate embodiments, the anatomical superior corners may have more or less rounding, and/or comprise multi-radiused corners to achieve optimal comfort and conformity to a wearer's hypogastric region.

The illustration in 209, FIG. 2B is a depiction of the ambulatory contouring of the device. In the preferred embodiment, the anatomical inferior corners are shaped with compound curvature. As opposed to a simple curve, a compound curve has a more natural arc which complements the motion of a wearer's thighs during ambulation. In alternate embodiments, the anatomical inferior corners may have larger or smaller radii, and/or the corner's profiles may consist of splines (defined herein as a line containing multiple curves), to further reduce impact upon a wearer's thighs.

The illustration in 505, FIG. 5B is a cross section of the hypogastric contouring of the device. The hypogastric contouring helps relieve acute contact on a wearer's lower abdomen, distributing the point of contact more evenly around the curve of said lower abdomen, thereby producing a more comfortable fit.

In an alternate embodiment, the device does not have hypogastric contouring.

In an alternate embodiment, the superior edge 221, FIG. 2B of the device may have a scalloped profile on the anatomical coronal plane, matching the shape of a wearer whose belly is more pronounced.

The illustration in 601, FIG. 6A is a depiction of the adductor contouring of the device. In the preferred embodiment, the device is contoured to reduce collision with a wearer's thighs. The stationary and movable jaws 1001-1003, FIG. 10A-10B, are recessed between a wearer's thighs by means of an ergonomic, symmetrical shape that follows the contours of a wearer's inner thigh/adductor region. These two anatomical inferior symmetrical faces start at a wearer's anterior thigh and curve radially inward on the anatomical transverse plane, around a wearer's adductors, and intersect at the anatomical mid-sagittal plane, forming the general contour of the gap between a wearer's thighs.

In the preferred embodiment, the device comprises pubic contouring, hypogastric contouring, adductor contouring, and ambulatory contouring. In an alternate embodiment (not shown), the device may utilize adductor and pubic contouring without the inclusion of ambulatory and/or hypogastric contouring. In this alternate embodiment, the overall shape is still a posteriorly-elongated vise which conforms ergonomically to the general contours of a wearers adductor, hypogastric and pubic regions, and thereby sits flush against a wearers crotch, but in this alternate embodiment, the anatomical inferior corners do not have ergonomic curvature and/or the device may not be ergonomically contoured around a wearer's lower abdomen.

In an alternate, primitive embodiment (not shown), the overall shape of the device is a still a posteriorly-elongated vise that fits within the recess of a wearer's crotch, but the ergonomic contours are absent; replaced by their reduced geometric equivalents. In this primitive embodiment, the anatomical superior medial face and the two anatomical inferior symmetrical face's ergonomics are replaced with planar faces, and curvatures are replaced with hard angles and straight lines. This primitive embodiment still utilizes a basic shape that compliments a wearers crotch; the genital collar is still parallel to a wearer's pubic symphyseal surface and the two anatomical inferior symmetrical faces are tangent to a wearer's adductor region.

In the preferred embodiment, the stationary and movable jaws are made of plastic, and the adjustment screw and the barrel nut are made of metal. In alternate embodiments, the stationary and movable jaws and the adjustment screw and barrel nut can be made of any combination of materials. These embodiments have different advantages and disadvantages over the preferred embodiment. For instance, an alternate embodiment where the stationary and movable jaws are made of chrome would give a wearer a more tactile sensory input from the feel of the metal, as metal is more conductive than plastic and therefore more sensitive to temperature changes.

The chrome metal quality of this embodiment may be perceived as an advantage or disadvantage to a wearer, depending upon, among other factors, their sensitivity to temperature. The increase in weight of this chrome metal embodiment may also be considered an advantage or disadvantage to a wearer. This embodiment may be perceived as too bulky and/or heavy (a disadvantage), or, due to the cosmetic appearance of the polished, heavier chrome material, may be perceived as more fashionable and higher quality, therefore perceived as more desirable (an advantage).

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention which is set forth in the following claims.

1. A testicle stimulation device comprising: testicle vise with ergonomic shaping, further comprising a movable jaw and a stationary jaw, a single tensioning drive comprising an adjustment screw and a barrel nut, an integrated, quick-connect hinge of said movable jaw and said stationary jaw; said movable jaw further comprises a catch plate to fasten said tensioning drive, and said stationary jaw further comprises a testicle divider, a genital collar, and a clevis pivot bracket for housing said barrel nut.

2. The testicle vise with ergonomic shaping of claim 1, wherein said ergonomic shaping comprises ambulatory contouring, adductor contouring, hypogastric contouring and pubic contouring.

3. The pubic contouring of claim 2, wherein said genital collar is contoured to complement the curve of a human's pubic region along said human's anatomical sagittal plane.

4. The hypogastric contouring of claim 2, wherein said genital collar is contoured to complement the curve of a human's hypogastric region along said human's anatomical transverse plane.

5. The adductor contouring of claim 2, wherein said stationary jaw is contoured to complement the curves of a human's adductors along said human's anatomical transverse plane.

6. The ambulatory contouring of claim 2, wherein the anatomically inferior corners of said movable jaw and said stationary jaw comprise compound curvature.

7. The single tensioning drive of claim 1, wherein said adjustment screw threads into said stationary jaw by means of said barrel nut, and the head of said adjustment screw is retained by said movable jaw by means of said catch plate.

8. The catch plate of claim 7, wherein said catch plate is sloped towards the inside of said device.

9. The integrated, quick-connect hinge of claim 1, wherein said movable jaw further comprises male hinge components, and said stationary jaw further comprises female hinge components.

10. The male hinge components of claim 9, wherein a plurality of laterally-oriented hinge pins are fixed to the anatomically superior edge of said movable jaw by means of a corresponding plurality of hinge arms.

11. The testicle divider of claim 1, wherein said testicle divider further comprises a central vertical ridge which extends from said clevis pivot bracket to said genital collar on the anatomically anterior face of said stationary jaw.

12. The female hinge components of claim 9, wherein said female hinge components comprises hinge cups and a hinge assembly guide, said hinge assembly guide further comprising a lateral sway limiter and a hinge pin alignment track.

13. The hinge pin alignment track of claim 12, wherein said hinge pin alignment track comprises a continuous lateral groove that is oriented coaxially to said hinge cups.

14. The lateral sway limiter of claim 12, wherein said lateral sway limiter comprises a plurality of chocks that are situated along the bottom edge of said continuous lateral groove.
